(19) United States
(12) Patent Application Publication
(10) Pub. No.: US 2018/0130625 A1
(43) Pub. Date: May 10, 2018

(54) ELECTROMAGNETIC RELAY

(71) Applicant: FUJITSU COMPONENT LIMITED, Tokyo (JP)

(72) Inventors: Kazuo KUBONO, Tokyo (JP); Takuji MURAKOSHI, Tokyo (JP)

(73) Assignee: FUJITSU COMPONENT LIMITED, Tokyo (JP)

(21) Appl. No.: 15/705,408

(22) Filed: Sep. 15, 2017

(30) Foreign Application Priority Data
Nov. 4, 2016 (JP) 2016-216653

(51) Int. Cl. H01H 50/56; H01H 50/64

(52) U.S. Cl. CPC H01H 50/56; H01H 50/64

(57) ABSTRACT

An electromagnetic relay including: a fixed terminal that includes a fixed contact; a movable spring that includes a movable piece on which a first through-hole is formed; a conductive plate that includes a second through-hole; a movable contact that includes a head part that is in contact with and is separated from the fixed contact, and a leg part that is inserted into the first through-hole and the second through-hole; wherein the conductive plate is disposed between the head part and the movable spring, in a radial direction of the first through-hole and the second through-hole, the head part does not protrude from an outer edge of the conductive plate but protrudes from the outer edge of the movable piece.

### CROSS-REFERENCE TO RELATED APPLICATION

This application is based upon and claims the benefit of priority of the prior Japanese Patent Application No. 2016-216653 filed on Nov. 4, 2016, the entire contents of which are incorporated herein by reference.

### FIELD

A certain aspect of the embodiments is related to an electromagnetic relay.

### BACKGROUND

There has been conventionally known an electromagnetic relay that fixes movable contacts to a movable spring and a conductive support member in order to increase a current-carrying capacity (see Patent Document 1: Japanese Laid-open Patent Publication No. 2015-191857). Moreover, there has been known an electromagnetic relay that increases a current-carrying capacity by overlapping multiple conductive plates (see Patent Document 2: Japanese Laid-open Patent Publication No. 2015-18763).

### SUMMARY

According to an aspect of the present invention, there is provided an electromagnetic relay including: a fixed terminal that includes a fixed contact; a movable spring that includes a movable piece on which a first through-hole is formed; a conductive plate that includes a second through-hole; a movable contact that includes a head part that is in contact with and is separated from the fixed contact, and a leg part that is inserted into the first through-hole and the second through-hole; wherein the conductive plate is disposed between the head part and the movable spring, in a radial direction of the first through-hole and the second through-hole, the head part does not protrude from an outer edge of the conductive plate but protrudes from the outer edge of the movable piece.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exploded view of an electromagnetic relay (hereinafter referred to as “a relay”) 1 according to a present embodiment;

FIG. 2 is a perspective view of the relay 1;

FIG. 3 is a side view of an armature 16;

FIG. 4A is a front view of a movable spring 18;

FIG. 4B is a side view of the movable spring 18;

FIG. 4C is a diagram illustrating the movable spring 18 on which movable contacts 36a and 36b are mounted;

FIG. 5A is a front view of a conductive plate 40;

FIG. 5B is a configuration diagram of the movable contacts 36a and 36b;

FIG. 5C is a partial enlarged view illustrating a state where the movable contact 36a is mounted on the movable spring 18 and the conductive plate 40;

FIG. 6A is a front view of fixed terminals 22a and 22b;

FIG. 6B is a side view of the fixed terminals 22a and 22b;

FIG. 7A is a diagram schematically illustrating a direction of a current flowing into the relay 1;

FIG. 7B is a diagram illustrating an arc-extinguishing state viewed from a fixed terminal 22a side;

FIG. 7C is a diagram illustrating an arc-extinguishing state viewed from a fixed terminal 22b side;

FIG. 8A is a diagram schematically illustrating a direction of a current flowing into the relay 1;

FIG. 8B is a diagram illustrating an arc-extinguishing state viewed from the fixed terminal 22a side;

FIG. 8C is a diagram illustrating an arc-extinguishing state viewed from the fixed terminal 22b side;

FIG. 9A is a diagram of a first variation of the movable spring 18 and the conductive plate 40;

FIG. 9B is a diagram of a second variation of the conductive plate 40;

FIG. 10A is a diagram of a third variation of the conductive plate 40;

FIG. 10B is a side view of the conductive plate 40 of FIG. 10A;

FIG. 10C is a diagram of a fourth variation of the conductive plate 40; and

FIG. 10D is a side view of the conductive plate 40 of FIG. 10C.

### DESCRIPTION OF EMBODIMENTS

In the case of increasing the current-carrying capacity, a current applied to a contact is increased and the heat generated by the contact is increased, it is therefore necessary to increase the size of the contact. However, depending on the size of the movable spring or conductive plate, the contact protrudes from the movable spring or the conductive plate when the size of the contact is increased. When the contacts protrudes from the movable spring or conductive plate, there is a problem that it is not possible to efficiently convey the current and the heat from the contact to the movable spring or the conductive plate.

A description will now be given of an embodiment according to the present invention with reference to drawings.

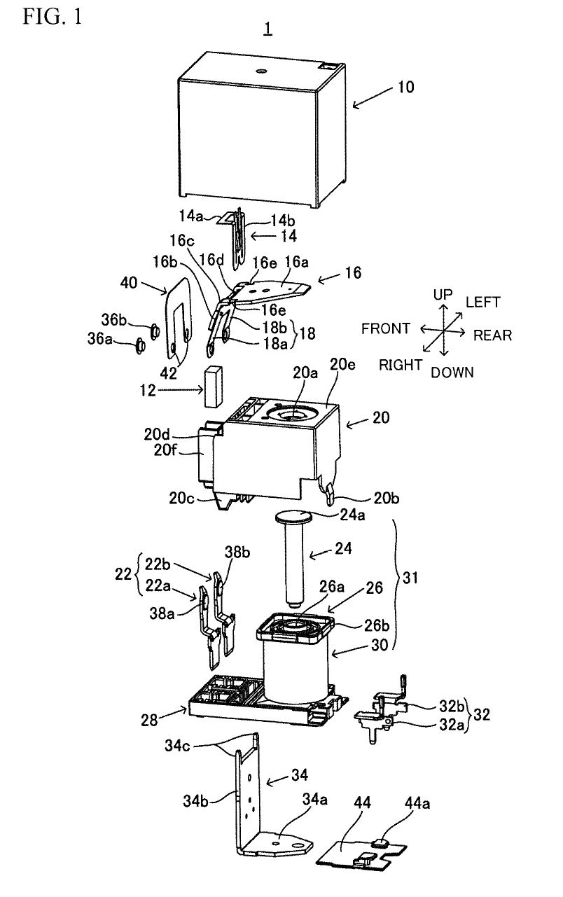

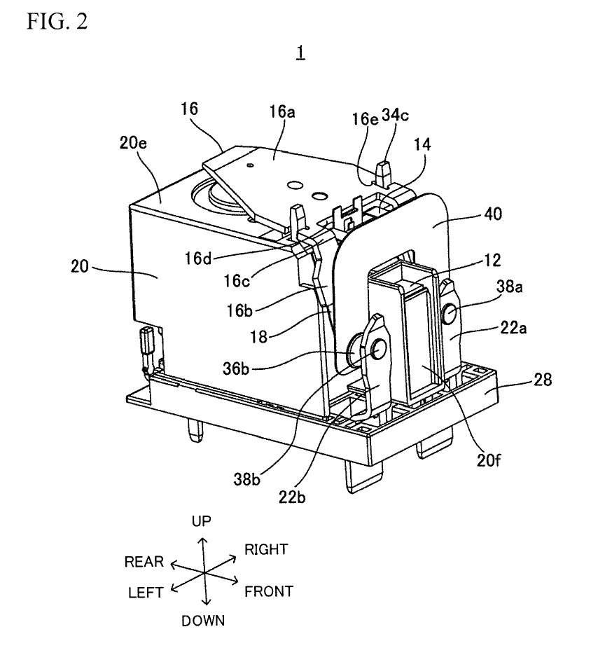

FIG. 1 is an exploded view of an electromagnetic relay (hereinafter referred to as “a relay”) according to a present embodiment. FIG. 2 is a perspective view of the relay.

A relay 1 according to the present embodiment is a relay adaptable to a high voltage, and is used as a relay for battery pre-charge of an electric vehicle (i.e., a relay for prevention of an inrush current to a main relay contact), for example.

When a high voltage load is shut off, the relay 1 is required to reliably extinguish an arc generated between a fixed contact and a movable contact. In a general DC high voltage relay, a polarity is designated for connection of a load side. On the other hand, in the relay 1 for the battery pre-charge, a direction of a current is reversed at the time of battery charging and discharging, and it is therefore required not to designate the polarity of the connection of the load side. Therefore, the relay 1 needs to extinguish the arc regardless of the direction of the current flowing between the movable contact and the fixed contact. Here, an application of the relay 1 is not limited to the electric vehicle, and the relay 1 can be used in various devices and equipment.

As illustrated in FIG. 1, the relay 1 includes a case 10, a permanent magnet 12 for arc-extinguishing, a hinge spring 14, an armature 16, a movable spring 18, a conductive plate 40, an insulating cover 20, fixed terminals 22 (22a, 22b), an iron core 24, a spool 26, a base 28, a coil 30, a pair of coil terminals 32 (32a, 32b), a yoke 34, and a fixed plate 44. The pair of coil terminals 32 supplies a current for excitation of an electromagnet device 31 having the iron core 24, the spool 26 and the coil 30.

A magnet holder 20f is formed on a front end of the insulating cover 20, and the permanent magnet 12 is held in the magnet holder 20f. A magnet holder 20f and the permanent magnet 12 are arranged between the fixed terminals 22a and 22b, as illustrated in FIG. 2. In FIG. 2, the case 10 is omitted. For example, a surface having an N-pole of the permanent magnet 12 is directed to the fixed terminal 22b side, and a surface having an S-pole of the permanent magnet 12 is directed to the fixed terminal 22a side. The position of the N-pole and S-pole may be reversed. Although the permanent magnet 12 is not required when an AC high voltage load is shut off, it is possible to promptly perform the arc-extinguishing by providing the permanent magnet 12.

Returning to FIG. 1, the hinge spring 14 is formed in an inverted L-shape in a side view, and includes a horizontal part 14a that biases downward a suspended part 16b of the armature 16 toward the base 28, and a suspended part 14b that is fixed to a vertical part 34b of the yoke 34.

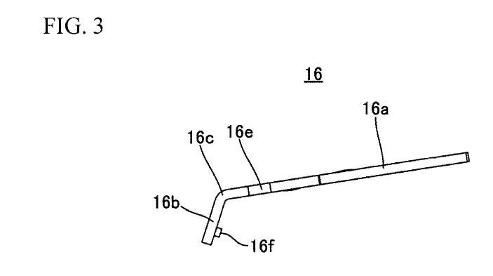

The armature 16 is a magnetic body having a dogleg shape in the side view, as illustrated in FIG. 3, and includes a flat plate part 16a that is attracted to the iron core 24, and the suspended part 16b that extends downward from the flat plate part 16a via a bending part 16c. Moreover, a through-hole 16d from which the hinge spring 14 protrudes is formed in the center of the bending part 16c, as illustrated in FIGS. 1 and 2. Moreover, cutout parts 16e in which projection parts 34c of the yoke 34 are fitted are formed on the flat plate part 16a. Projections 16f for fixing the movable spring 18 to the suspended part 16b by caulking are provided on the suspended part 16b (see FIG. 3).

The armature 16 rotates using the cutout parts 16e as a fulcrum into which the projection parts 34c of the yoke 34 are fitted. When the current flows into the coil 30, the iron core 24 attracts the flat plate part 16a. At this time, the horizontal part 14a of the hinge spring 14 is in contact with the suspended part 16b, and is pushed upward by the suspended part 16b. When the current of the coil 30 is cut, the suspended part 16b is pushed down by a restoring force of the horizontal part 14a of the hinge spring 14. Thereby, the flat plate part 16a is separated from the iron core 24. Here, a surface of the flat plate part 16a opposite to the iron core 24 or the insulating cover 20 is defined as a first surface, and a back side of the first surface is defined as a second surface. Moreover, a surface of the suspended part 16b opposite to the yoke 34 or the insulating cover 20 is defined as the first surface, and a back side of the first surface is defined as the second surface.

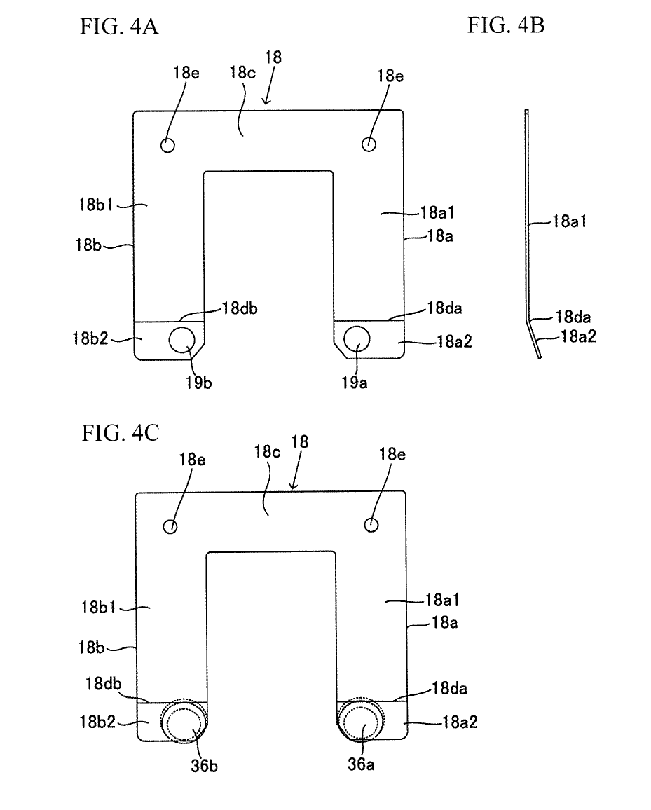

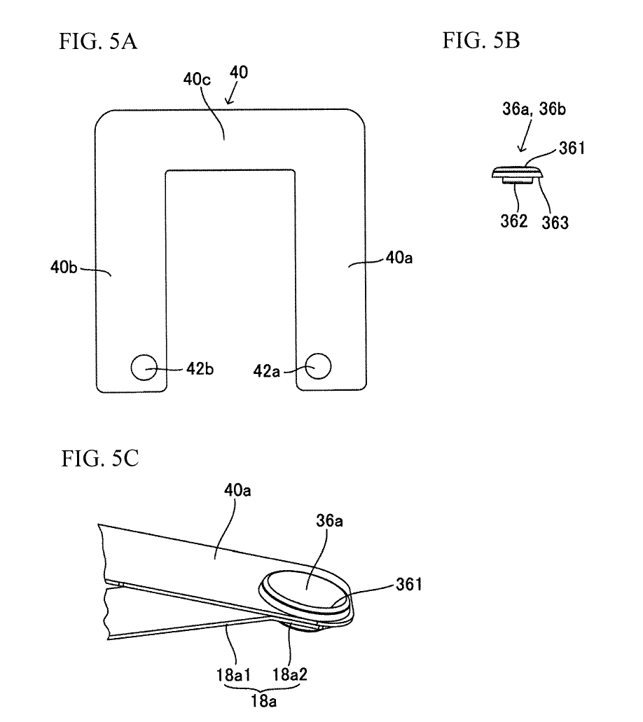

FIG. 4A is a front view of the movable spring 18. FIG. 4B is a side view of the movable spring 18. FIG. 4C is a diagram illustrating the movable spring 18 on which movable contacts 36a and 36b are mounted. FIG. 5A is a front view of the conductive plate 40. FIG. 5B is a configuration diagram of the movable contacts 36a and 36b. FIG. 5C is a partial enlarged view illustrating a state where the movable contact 36a is mounted on the movable spring 18 and the conductive plate 40.

As illustrated in FIG. 4A, the movable spring 18 is a conductive plate spring having a U-shape in the front view, and is made of a copper alloy, for example. The movable spring 18 includes a pair of movable pieces, i.e., a first movable piece 18a and a second movable piece 18b, and a coupling part 18c that couples upper ends of the first movable piece 18a and the second movable piece 18b.

The first movable piece 18a and the second movable piece 18b are bent at positions 18da and 18db closer to lower ends than centers thereof in a longitudinal direction, respectively. Here, a part of the first movable piece 18a closer to the coupling part 18c than the position 18da is defined as an upper part 18a1, and a part of the first movable piece 18a closer to a tip side than the position 18da is defined as a lower part 18a2. Similarly, a part of the second movable piece 18b closer to the coupling part 18c than the position 18db is defined as an upper part 18b1, and a part of the second movable piece 18b closer to a tip side than the position 18db is defined as a lower part 18b2. The lower part 18a2 and the lower part 18b2 serve as flat parts that fix the movable contacts 36a and 36b thereto, respectively.

A through-hole 19a for fixing the movable contact 36a by caulking is provided on the lower part 18a2 of the first movable piece 18a. A through-hole 19b for fixing the movable contact 36b by caulking is provided on the lower part 18b2 of the second movable piece 18b. Each of the through-holes 19a and 19b serves as a first through-hole. The lower parts 18a2 and 18b2 are bent against the upper parts 18a1 and 18b1 in a direction where the movable contacts 36a and 36b are away from the fixed contacts 38a and 38b, respectively.

Through-holes 18e into which the projections 16f of the suspended part 16b are fitted are formed on the coupling part 18c. The projections 16f are fitted into and caulked to the through-holes 18e, so that the movable spring 18 is fixed to the first surface of the suspended part 16b.

When the movable contacts 36a and 36b are mounted on the movable spring 18, the movable contact 36a protrudes from the lower part 18a2 and the movable contact 36b protrudes from the lower part 18b2, as illustrated in FIG. 4C. In this case, the current and the heat cannot be conveyed efficiently from the movable contacts 36a and 36b to the movable spring 18.

The conductive plate 40 illustrated in FIG. 5A has a U-shape in a front view, and is made of copper, for example. The conductive plate 40 has a higher conductivity and a higher thermal conductivity than the movable spring 18. The conductive plate 40 includes a pair of leg pieces, i.e., a first leg piece 40a and a second leg piece 40b, and a coupling part 40c that couples upper ends of the first leg piece 40a and the second leg piece 40b. A through-hole 42a for fixing the movable contact 36a to the first movable piece 18a by caulking is provided on a lower end of the first leg piece 40a. A through-hole 42b for fixing the movable contact 36b to the second movable piece 18b by caulking is provided on a lower end of the second leg piece 40b.

The through-holes 42a and 42b serve as second through-holes into which leg parts 362 of the movable contacts 36a and 36b are inserted.

As illustrated in FIG. 5B, each of the movable contacts 36a and 36b has a rivet-like shape, and include a head part 361 that is in contact with the fixed contact 38a or 38b, and a leg part 362 that is inserted into the through-hole 19a or 19b of the movable spring 18 and the through-hole 42a or 42b of the conductive plate 40. The movable contact 36a is fixed to the conductive plate 40 and the movable spring 18 by caulking in a state of aligning the positions of the through-hole 19a and the through-hole 42a. The movable contact 36b is fixed to the conductive plate 40 and the movable spring 18 by caulking in a state of aligning the positions of the through-hole 19b and the through-hole 42b. When the movable contacts 36a and 36b are fixed to the conductive plate 40 and the movable spring 18 by caulking, a contact surface 363 of the head part 361 is in contact with the conductive plate 40.

When the movable contact 36a is fixed to the conductive plate 40 and the movable spring 18 by caulking as illustrated in FIG. 5C, the head part 361 of the movable contact 36a protrudes from an outer edge of the lower part 18a2 of the movable spring 18 in a radial direction of the head part 361, but is fixed so as not to protrude from an outer edge of the first leg piece 40a of the conductive plate 40. Similarly, when the movable contact 36b is fixed to the conductive plate 40 and the movable spring 18 by caulking, the head part 361 of the movable contact 36b is fixed so as not to protrude from an outer edge of the second leg piece 40b of the conductive plate 40 in the radial direction of the head part 361. Moreover, when the movable contacts 36a and 36b are fixed to the conductive plate 40 and the movable spring 18 by caulking, the conductive plate 40 is disposed between the movable spring 18 and the contact surface 363. That is, the contact surface 363 of the head part 361 is in contact with the conductive plate 40. Thus, in the present embodiment, since the conductive plate 40 is disposed between the movable spring 18 and the contact surface 363 so that the whole of the contact surface 363 is in contact with the conductive plate 40, it is possible to efficiently convey the current and the heat from the movable contacts 36a and 36b to the conductive plate 40, and increase a current-carrying capacity of the relay.

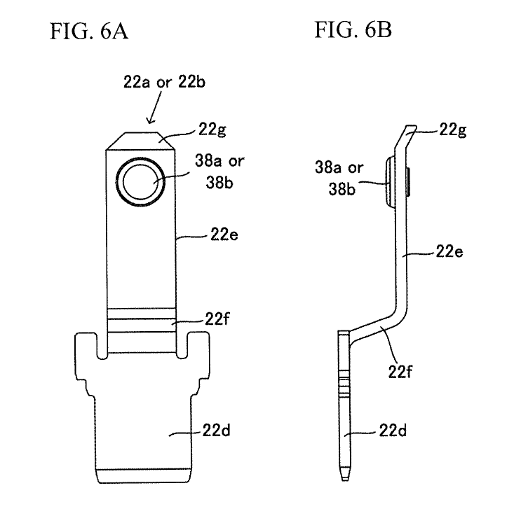

FIG. 6A is a front view of fixed terminals 22a and 22b. FIG. 6B is a side view of the fixed terminals 22a and 22b.

The fixed terminals 22a and 22b are press-fitted from above into through-holes, not shown, provided on the base 28, and are fixed to the base 28. The fixed terminals 22a and 22b are bent in a crank shape in the side view, and each of the fixed terminals 22a and 22b includes an upper part 22e, an inclined part 22f and a lower part 22d. The upper part 22e is coupled with the lower part 22d via the inclined part 22f. The upper part 22e, the inclined part 22f and the lower part 22d are integrally formed. The lower part 22d is connected to a power supply, not shown, and becomes a blade terminal to improve current-carrying performance. Since the lower part 22d becomes the blade terminal, the lower part 22d increases a contact area to the substrate compared with a forked terminal for example, thereby improving the current-carrying performance. The upper part 22e is bent so as to be away from the movable spring 18 and the conductive plate 40 than the lower part 22d. An upper end 22g of the upper part 22e is bent so as to be away from the movable spring 18 and the conductive plate 40 than other portion of the upper part 22e. The fixed contacts 38a and 38b are provided on the upper parts 22e of the fixed terminals 22a and 22b, respectively.

With reference to FIG. 1 again, the insulating cover 20 is made of resin. A ceiling part 20e of the insulating cover 20 has a through-hole 20a that exposes a head part 24a of the iron core 24. In order to fix the insulating cover 20 to the base 28, projection-shaped fixed parts 20b and 20c are formed on the bottom of the insulating cover 20. The fixed part 20b engages with one end of the base 28, and the fixed part 20c is inserted into a hole, not shown, of the base 28. Moreover, a backstop 20d made of resin is integrally formed with the insulating cover 20. When no current flows into the coil 30 and the electromagnet device 31 is turned off, the backstop 20d acting as a stopper is in contact with the movable spring 18. The backstop 20d can suppress the generation of a collision sound between metal components such as the movable spring 18 and the yoke 34, and therefore the backstop 20d can reduce an operation sound of the relay 1.

The iron core 24 is inserted into a through-hole 26a formed in a head part 26b of the spool 26. The spool 26 is formed integrally with the base 28 and the coil 30 is wound around the spool 26. The iron core 24, the spool 26 and the coil 30 form the electromagnetic device 31. The electromagnetic device 31 attracts the flat plate part 16a of the armature 16 or cancels the attraction of the flat plate part 16a in accordance with on/off of the current. Thereby, opening or closing operation of the movable spring 18 with respect to the fixed terminals 22a and 22b is performed. The pair of the coil terminals 32 is press-fitted into the base 28. The coil 30 is entwined with each of the coil terminals 32.

The yoke 34 is made of a conductive material having an L shape in the side view, and includes a horizontal part 34a to be fixed to a back surface of the base 28 and the vertical part 34b provided vertically to the horizontal part 34a. From the bottom of the base 28, the vertical part 34b is press-fitted into through-holes, not shown, of the base 28 and the insulating cover 20. Thereby, the projection parts 34c provided on both upper edges of the vertical part 34b project from the ceiling part 20e of the insulating cover 20, as illustrated in FIG. 2. The fixed plate 44 includes hook parts 44a for fixing the fixed plate 44 to the horizontal part 34a, and the fixed plate 44 is fixed to the back surface of the base 28.

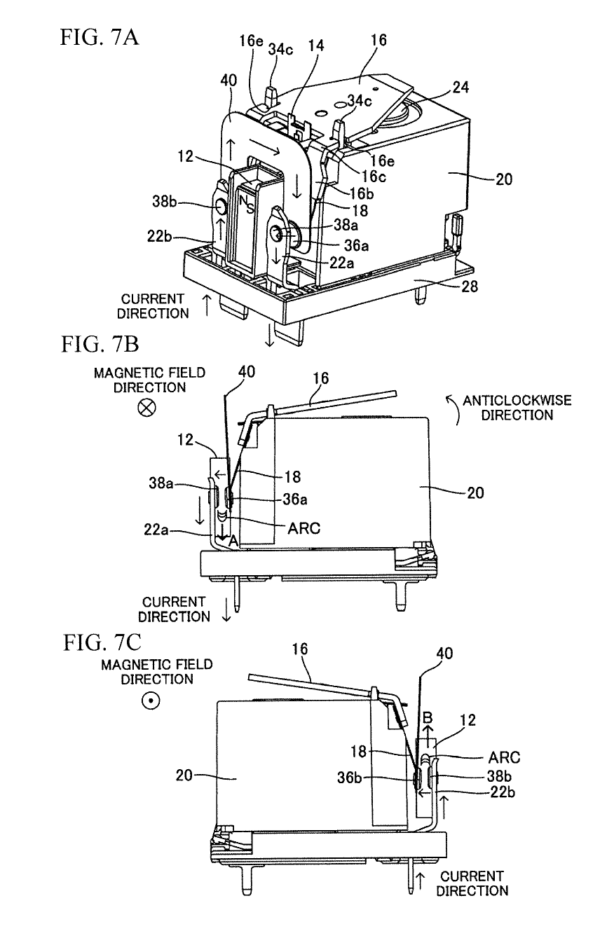

FIG. 7A schematically illustrates the direction of the current flowing into the relay 1 and, in particular, illustrates a state where the fixed contact is away from the movable contact. FIG. 7B illustrates an arc-extinguishing state viewed from a fixed terminal 22a side. FIG. 7C illustrates an arc-extinguishing state viewed from a fixed terminal 22b side. In FIG. 7A to FIG. 7C, the direction of the current is illustrated with arrows.

In FIG. 7A, any one of the fixed terminals 22a and 22b is connected to a power supply side, not shown, and the other is connected to a load side, not shown. When the current flows in the coil 30, the iron core 24 attracts the flat plate part 16a and the armature 16 rotates under a condition that the projection parts 34c and the cutout parts 16e act as a supporting point. With the rotation of the armature 16, the suspended part 16b and the movable spring 18 rotate toward a fixed terminal 22 side, and then the movable contacts 36a and 36b are in contact with the corresponding fixed contacts 38a and 38b, respectively. When a voltage is applied to the fixed terminal 22b as a positive pole side in a state where the movable contacts 36a and 36b are in contact with the fixed contacts 38a and 38b, the current flows in the fixed terminal 22b, the fixed contact 38b, the movable contact 36b, the conductive plate 40, the movable spring 18, the movable contact 36a, the fixed contact 38a and the fixed terminal 22a in this order as illustrated in FIG. 7A. Here, the current flows in both of the conductive plate 40 and the movable spring 18 between the movable contacts 36a and 36b. When the current flowing in the coil 30 is shut off, the restoring force of the hinge spring 14 rotates the armature 16 anticlockwise illustrated in FIG. 7B. Due to the rotation of the armature 16, the movable contacts 36a and 36b start to separate from the fixed contacts 38a and 38b, respectively. However, since an arc occurs between the fixed contacts 38a and 38b and the movable contacts 36a and 36b, the current flowing between the movable contact 36a and the fixed contact 38a and the current flowing between the movable contact 36b and the fixed contact 38b are not completely shut off.

In the relay 1 illustrated in FIGS. 7A to 7C, a direction of a magnetic field is directed from the fixed terminal 22a to the fixed terminal 22b, as illustrated in FIG. 7B. Therefore, an arc generated between the movable contact 36a and the fixed contact 38a is extended to a space in a lower direction toward the base 28 by Lorentz force as indicated by an arrow A of FIG. 7B and is extinguished. On the other hand, an arc generated between the movable contact 36b and the fixed contact 38b is extended to a space in an upper direction separated from the base 28 by the Lorentz force as indicated by an arrow B of FIG. 7C and is extinguished.

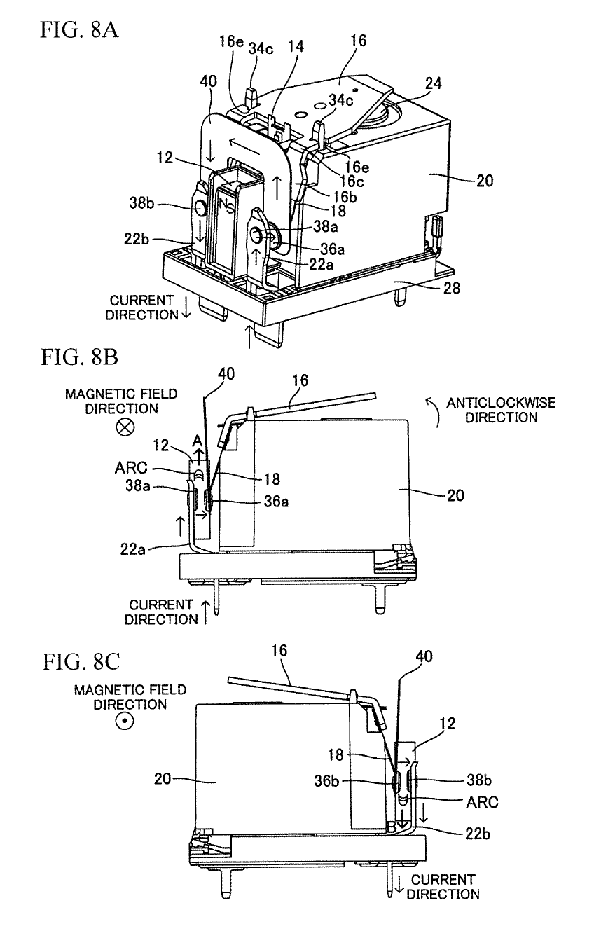

FIG. 8A schematically illustrates the direction of the current flowing into the relay 1. FIG. 8B illustrates an arc-extinguishing state viewed from the fixed terminal 22a side. FIG. 8C illustrates an arc-extinguishing state viewed from the fixed terminal 22b side. Here, the direction of the current is opposite to that of the current of FIGS. 7A to 7C.

In FIG. 8A, any one of the fixed terminals 22a and 22b is connected to the power supply side, and the other is connected to the load side, as with FIG. 7A. When the voltage is applied to the fixed terminal 22a as the positive pole side in the state where the movable contacts 36a and 36b are in contact with the fixed contacts 38a and 38b, the current flows in the fixed terminal 22a, the fixed contact 38a, the movable contact 36a, the conductive plate 40, the movable spring 18, the movable contact 36b, the fixed contact 38b and the fixed terminal 22b in this order as illustrated in FIG. 8A. When the current flowing in the coil 30 is shut off, the restoring force of the hinge spring 14 rotates the armature 16 anticlockwise illustrated in FIG. 8B, and the movable contacts 36a and 36b separate from the fixed contacts 38a and 38b, respectively.

Also in the relay 1 illustrated in FIGS. 8A to 8C, the direction of the magnetic field is directed from the fixed terminal 22a to the fixed terminal 22b. Therefore, the arc generated between the movable contact 36a and the fixed contact 38a is extended to the space in the upper direction by Lorentz force as indicated by an arrow A of FIG. 8B and is extinguished. On the other hand, the arc generated between the movable contact 36b and the fixed contact 38b is extended to the space in the lower direction toward the base 28 by the Lorentz force as indicated by an arrow B of FIG. 8C and is extinguished.

Therefore, according to the relay 1 of the present embodiment, regardless of the direction of the current flowing between the movable contact 36a and the fixed contact 38a and between the movable contact 36b and the fixed contact 38b, the arc generated between the movable contact 36a and the fixed contact 38a and the arc generated between the movable contact 36b and the fixed contact 38b can be extended to the opposite spaces at the same time, respectively, and be extinguished.

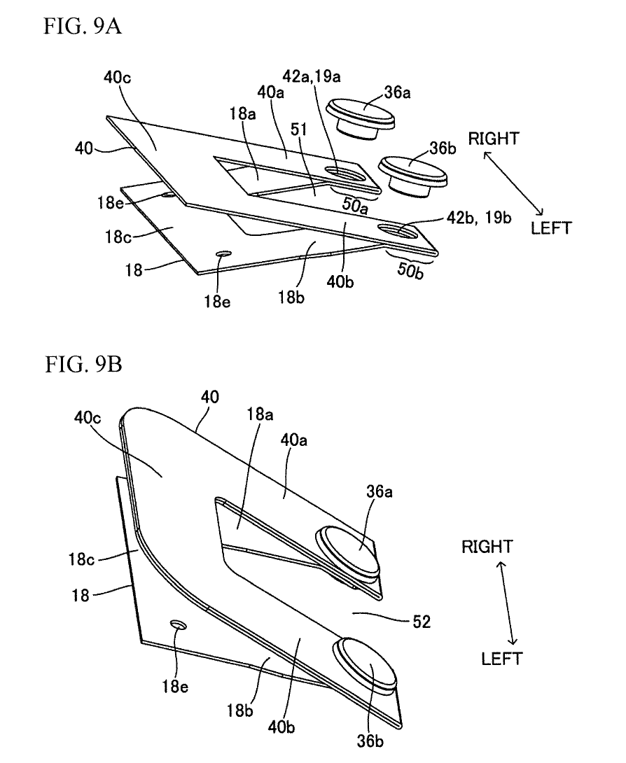

FIG. 9A is a diagram of a first variation of the movable spring 18 and the conductive plate 40. FIG. 9B is a diagram of a second variation of the conductive plate 40.

The movable spring 18 and the conductive plate 40 may be integrally formed by bending a metal plate of which a rectangular through-hole 51 is formed in the center, as illustrated in FIG. 9A. In this case, the through-holes 42a and 19a and the through-holes 42b and 19b are formed on edge parts 50a and 50b each of which is folded and superimposed, respectively. The through-holes 42a and 19a and the through-holes 42b and 19b are formed at a time by press processing. Since the movable spring 18 and the conductive plate 40 is formed with a single conductive plate, it is possible to reduce the number of parts and make assembly process more efficient. Moreover, since the through-holes 42a and 19a and the through-holes 42b and 19b are formed at a time on the edge parts 50a and 50b each of which is folded and superimposed, it is possible to avoid the displacement of the through-holes 42a and 19a and the displacement of the through-holes 42b and 19b and make assembly process more efficient.

By bending a thin metal plate of which a rectangular through-hole 52 is formed in the center, a two-ply conductive plate 40 may be formed as illustrated in FIG. 9B. It is possible to suppress the increase in a rigidity and improve the current-carrying capacity as compared with a single thick conductive plate.

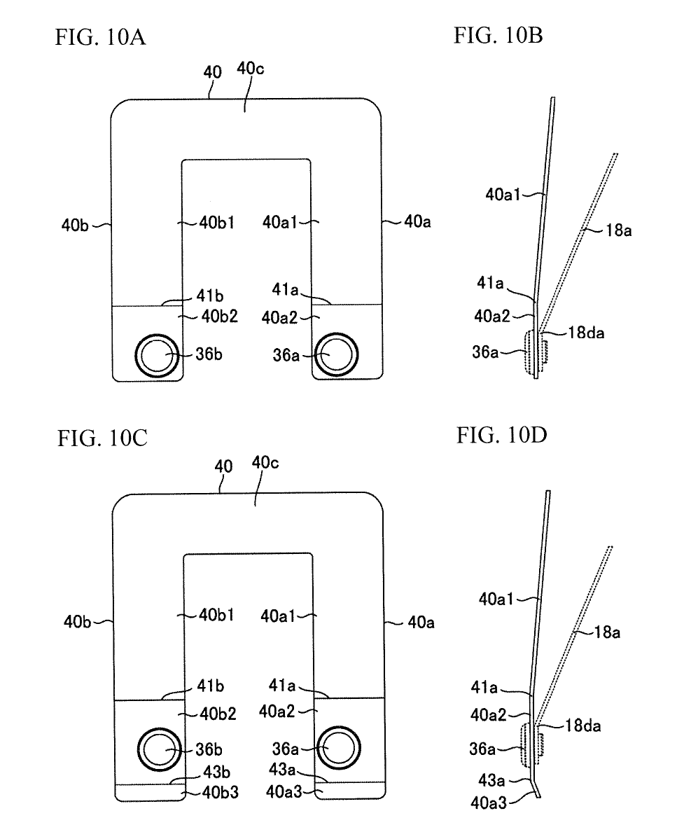

FIG. 10A is a diagram of a third variation of the conductive plate 40. FIG. 10B is a side view of the conductive plate 40 of FIG. 10A. FIG. 10C is a diagram of a fourth variation of the conductive plate 40. FIG. 10D is a side view of the conductive plate 40 of FIG. 10C.

As illustrated in FIGS. 10A and 10B, the first leg piece 40a and the second leg piece 40b of the conductive plate 40 may be bent at positions 41a and 41b where the movable contacts 36a and 36b fixed by caulking do not protrude upward. Here, a part of the first leg piece 40a that is lower than the position 41a is defined as a lower part 40a2. A part of the first leg piece 40a that is upper than the position 41a is defined as an upper part 40a1. Similarly, a part of the second leg piece 40b that is lower than the position 41b is defined as a lower part 40b2. A part of the second leg piece 40b that is upper than the position 41b is defined as an upper part 40b1. The lower parts 40a2 and 40b2 serve as a first domain, and the upper parts 40a1 and 40b1 serve as a second domain adjacent to the first domain.

The upper parts 40a1 and 40b1 and the coupling part 40c are bent in a direction away from the fixed contact 38a and 38b with which the movable contacts 36a and 36b are in contact. In this case, since clearances between the fixed terminals 22a and 22b and the conductive plate 40 are gradually spread upward from the fixed terminal 22a and 22b, the arc can be extinguished efficiently while being moved to the space in the upper direction.

Moreover, as illustrated in FIGS. 10C and 10D, the first leg piece 40a and the second leg piece 40b of the conductive plate 40 may be bent at positions 43a and 43b where the movable contacts 36a and 36b do not protrude downward. Here, the lower part 40a2 corresponds to a part between the positions 41a and 43a, and the lower part 40b2 corresponds to a part between the positions 41b and 43b. A part of the first leg piece 40a that is lower than the position 43a is defined as a lowermost part 40a3. A part of the second leg piece 40b that is lower than the position 43b is defined as a lowermost part 40b3.

The lowermost parts 40a3 and 40b3 are bend in a direction away from the fixed contacts 38a and 38b, respectively. In this case, since the clearances between the fixed terminals 22a and 22b and the conductive plate 40 are gradually spread downward from the fixed terminal 22a and 22b, the arc can be extinguished efficiently while being moved to the space in the lower direction by the lowermost parts 40a3 and 40b3.

As described above, in the present embodiment, the conductive plate 40 is disposed between the head part 361 and the movable spring 18, and in the radial direction of the through-holes 19a and 19b of the movable spring 18 and the through-holes 42a and 42b of the conductive plate 40, the head part 361 does not protrude from the outer edge of the conductive plate 40 even when protrudes from the outer edge of the lower parts 18a2 and 18b2. Therefore, since the conductive plate 40 with which the whole of the head part 361 is in contact is disposed between the head part 361 and the lower parts 18a2 and 18b2 of the movable spring 18, it is possible to efficiently convey the current and the heat from the movable contact 36a and 36b to the conductive plate 40 and increase the current-carrying capacity. Moreover, the leg part 362 fixed by caulking does not protrude from the outer edge of the lower parts 18a2 and 18b2 in the radial direction of the through-holes 19a and 19b.

Since the conductive plate 40 that increases the current-carrying capacity is provided, a freedom degree of the design of the spring load is improved without considering the current-carrying capacity of the movable spring 18. Even if there is a structural constraint that prohibit changing the size of the movable spring 18, it is possible to improve the current-carrying capacity by providing the conductive plate 40. Moreover, since the conductive plate 40 is made of a material having the high thermal conductivity, it is possible to efficiently cool the heat of the arc and improve the opening and closing performance of the movable contact 36a and 36b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An electromagnetic relay comprising:
a fixed terminal that includes a fixed contact;
a movable spring that includes a movable piece on which a first through-hole is formed;
a conductive plate that includes a second through-hole;
a movable contact that includes a head part that is in contact with and is separated from the fixed contact, and a leg part that is inserted into the first through-hole and the second through-hole;
wherein the conductive plate is disposed between the head part and the movable spring,
in a radial direction of the first through-hole and the second through-hole, the head part does not protrude from an outer edge of the conductive plate but protrudes from the outer edge of the movable piece.

2. The electromagnetic relay as claimed in claim 1, wherein the conductive plate has a higher conductivity and a higher thermal conductivity than the movable spring.

3. The electromagnetic relay as claimed in claim 1, wherein the conductive plate is made of a two-ply conductive plate.

4. The electromagnetic relay as claimed in claim 1, wherein the conductive plate includes a first domain on which the movable contact is disposed, and a second domain adjacent to the first domain, the second domain is bent in a direction away from the fixed contact.

5. The electromagnetic relay as claimed in claim 1, wherein the conductive plate is formed integrally with the movable spring.

6. The electromagnetic relay as claimed in claim 1, wherein
the fixed terminal includes a first fixed terminal and a second fixed terminal each of which includes the fixed contact,
the movable spring includes a first movable piece and a second movable piece on each of which the first through-hole is formed;
the electromagnetic relay further includes:
an electromagnet device that drives an armature to be coupled with the movable spring, and
a cover that covers the electromagnet device.
